(19) United States
(12) Patent Application Publication
(10) Pub. No.: US 2015/0285611 A1
(43) Pub. Date: Oct. 8, 2015

(54) NEAR-FIELD MAGNETIC OBJECT TRACKING

(71) Applicants: Andrew D. Lowery, Morgantown, WV (US); Franz A. Pertl, Morgantown, WV (US); James E. Smith, Bruceton Mills, WV (US)

(72) Inventors: Andrew D. Lowery, Morgantown, WV (US); Franz A. Pertl, Morgantown, WV (US); James E. Smith, Bruceton Mills, WV (US)

(21) Appl. No.: 14/263,514

(22) Filed: Apr. 28, 2014

Related U.S. Application Data
(60) Provisional application No. 61/816,410, filed on Apr. 26, 2013.

(51) Int. Cl. G01B 7/004

(52) U.S. Cl. CPC G01B 7/004

(57) ABSTRACT

An object tracking system includes a sensor grid having a plurality of sensor clusters configured to sense the presence of a magnetic field of an object. Each sensor cluster includes three or more single-axis magnetic sensors. The sensors in a cluster may be arranged with their axes parallel to one another. The sensor grid may account for ambient magnetic noise by measuring the magnetic field in a zone a distance away from the object to update the ambient magnetic field noise measurement. The sensor grid or a portion thereof may include a plurality of sensors printed on a common sheet. The sensor grid may comprise one or more sheets overlapped or interconnected. The system may track an object and determine up to three degrees of positioning and three degrees of orientation by using a geometric solution of the intercepts of magnetic field strengths obtained from information collected by the magnetic sensors.

### CROSS-REFERENCE TO RELATED APPLICATIONS

This application claims priority to U.S. Provisional Patent Application No. 61/816,410 entitled “NEAR-FIELD MAGNETIC OBJECT TRACKING,” filed on Apr. 26, 2013, which is hereby incorporated by reference in its entirety.

### FIELD OF THE INVENTION

The present invention relates generally to a tracking system, and more particularly, to a system for determining position and orientation of a magnetic source in three-dimensional space from single-axis, co-linear clusters of sensors.

### BACKGROUND OF THE INVENTION

There is a constant need for technologies capable of tracking an object's position. In the field of transportation, there is a need to track the position of ships, airplanes, vehicles, etc. Military activities have always required the use of position tracking, such as the need to determine the position of a bombing target. Law enforcement agencies frequently need to determine the position of a subject individual or object, such as a package of contraband, within a search area. On a smaller scale, there is a need for technology to track precisely an object's position within a small volume. For example, three-dimensional computer design tools for animated films often map the position of one or more optical position reflectors located on selected portions of an actor's body. In the field of medicine, position tracking is frequently used, for example to locate the position of a tumor. In one example, gamma ray sources are injected into a patient and accumulate at the location of a tumor, identifying its position, or to monitor digestive or vascular flow and blockage.

A variety of position tracking technologies have been developed to determine the location of an object of interest, both at global distances and smaller distances, with a range of resolutions from tens of meters to tens of millimeters. These tracking technologies include GPA, RADAR, LIDAR, and Electromagnetic propagation detection among others. One such Electromagnetic propagation technology includes magnetic field tracking. Magnetic fields and their principles have been well studied and are well defined. Because of this, there are wide spread possibilities for practical applications. Previously researched technical embodiments using magnetic fields include, but are not limited to: medical applications, theories of biological effect, wireless identification, thermal processes, and audio and video processing. Additionally, magnetic fields can be used for tracking applications within these embodiments.

While magnetic tracking applications have been developed, most such applications are limited by accuracy, cost, size, and especially speed of use (computational limitations). These systems are made using both alternating current (AC) and pulsed direct current (DC) magnetic fields. Generally, AC systems have high resolution and accuracy, but perform very poorly in the presence of conducting magnetic materials such as carbon steel and other ferrous metals. This is mainly due to the fact that the system's alternating current produces magnetic noise, in the form of eddy currents within those materials or in conjunction with them, which interfere with the final resolution.

Therefore, DC systems may be viable and desirable alternatives. It has been suggested that pure DC systems are not feasible because there is no way to account for the presence of the Earth's magnetic field. The traditional solution to this problem is through the use of pulsed DC magnetic sources. Pulsed DC tracking has the benefit of not inducing continuous eddy currents in relatively close proximity to magnetic materials, such as those created with AC systems, thus increasing its overall accuracy potential. The downfall of pulsed DC systems, however, is that additional hardware components as needed to create and detect the discrete signal.

Current tracking systems use a wide array of sensing technologies, with foundations in both AC and pulsed DC magnetic fields, including magnetometers, magneto-diodes, magneto-transistors, and Hall-effect sensors. These sensors have their own detectable fields, which range from 100 nano-Gauss to 100 kilo-Gauss, based on their given applications. Likewise, these systems employ both passive and active targets. Passive sources have the benefit of simplicity and uniformity, such as a standard magnet. Active sources can, however, be designed and tuned to a wide variety of operating conditions.

Some problems with current magnetic tracking begins to emerge when the source object and the sensors are separated by large distances, the source object and/or the sensor begins to travel at a high rate of speed relative to one another, or when magnetic noise is introduced between the source object and the detection sensor. In order to compensate for these limitations, magnetic tracking systems are usually implemented in distance-limited applications, with magnetic sources traveling only at nominal speeds, in closely monitored environmental conditions.

Therefore, an improved tracking system is needed to address the aforementioned concerns.

### SUMMARY

A system and method utilizing single axis magnetic sensors to locate and track the position and orientation of a magnetic source in three-dimensional space are generally presented. The system may include a sensor grid having a plurality of sensor clusters configured to sense the presence of a magnetic field of an object. Each sensor cluster may comprise three or more single-axis magnetic sensors, and the sensors in a cluster may be arranged with their axes parallel to one another. The sensor grid may be configured to determine ambient magnetic noise by measuring the magnetic field in a first zone near the object and measuring the magnetic field at a second zone away from the object and comparing the first zone measurement with the second zone measurement.

One possible embodiment may incorporate a sensor grid placed in or under an area of interest to be used in threshold detection. This is be used for applications such as security or inventory management. On a larger scale, a sensor network couple be deployed to look at personnel movement in an enclosed space such as a secured office building. Likewise, an addition embodiment could include medical tracking and mapping. This method could potentially allow for mapping in the intestinal tract or the blood stream once operating on milli- or nano-scales.

The proposed method consists of triangulating the position and motion from one-axis sensor clusters layout in a predetermined grid, and to process the sensor grid data with position based on estimation techniques and motion tracking based on kinematic models. This novel method of tracking aims to use the benefit of not needing a line-of-sight requirement for constant communication between source and receiver. An implementation using magnetics was described as a preferred embodiment.

### DESCRIPTION OF THE DRAWINGS

Operation of the invention may be better understood by reference to the following detailed description taken in connection with the following illustrations, wherein:

FIG. 1 illustrates the orientation of sensor cluster comprised of three planar z-axis magnetic sensors.

FIG. 2 illustrates a uniform sensor layout of sensor clusters.

FIG. 3 illustrates the simulated magnetic flux density of a 1 kG magnetic source at z=9.84 ft above origin with orientation of 0° about x-axis.

FIG. 4 illustrates the simulated magnetic field lines of a 1 kG magnetic source at origin with orientation of 0° about x-axis.

FIG. 5 illustrates the simulated magnetic flux density of a 1 kG magnetic source at z=9.84 ft above origin with orientation of 90° about x-axis.

FIG. 6 illustrates the simulated magnetic field lines of a 1 kG magnetic source at origin with orientation of 90° about x-axis.

FIG. 7 illustrates the simulated magnetic flux density of a 1 kG magnetic source at z=9.84 ft above origin with orientation of 180° about x-axis.

FIG. 8 illustrates the simulated magnetic field lines of a 1 kG magnetic source at origin with orientation of 180° about x-axis.

FIG. 9 illustrates the simulated magnetic flux density of a 1 kG magnetic source at z=9.84 ft above origin with orientation of 270° about x-axis.

FIG. 10 illustrates the simulated magnetic field lines of a 1 kG magnetic source at origin with orientation of 270° about x-axis.

FIG. 11 illustrates the simulated plot of the intersection of Patch normal vectors in 3D (left) and 2D (right) space.

FIG. 12 illustrates the intersection of normal vectors in two-dimensional space on the x-y plane.

FIG. 13 illustrates (x,y) position for all combination of point-normal intersections.

FIG. 14 illustrates a plot of elevation angle vs. ratio of simulated sensor values (max/min) for 12≦z≦48 in

FIG. 15 illustrates a plot of simulated rotation angle vs. sensor position.

FIG. 16 illustrates a plot of 0 vs. Equivalent Bᵣ in the z-axis based on maximum sensor value.

FIG. 17 illustrates a radial offset percentage for elevated magnet (z=12, 24, 36, and 48 inches).

FIG. 18 illustrates the path of projectile with and without AWGN and with applied Kalman filter.

FIG. 19 illustrates the percent error of Kalman filter and smoothed Kalman filter in free-space.

FIG. 20 illustrates a tracking system block diagram.

FIG. 21 illustrates an embodiment of a magnetic object tracking system.

FIG. 22 illustrates an AMR Magnetic Field Sensor.

FIG. 23 illustrates a sensor network with combined layers.

FIG. 24 illustrates a sensor network with combined layers

### DETAILED DESCRIPTION

While the invention is described herein with reference to several embodiments, it should be clear that the invention should not be limited only to the embodiments disclosed or discussed. The description of the embodiments herein is illustrative of the invention and should not limit the scope of the invention as described or claimed.

A method used to locate and track a magnetic source, both position and orientation, in three-dimensional space through a magnetically noisy environment, is generally presented. It is well known that the tracking of moving objects can be accomplished with a strategic arrangement of a multitude of sensors, such as a sensor grid arrangement. For this application, these sensors could be of a single type, such as a magnetic type sensor, or a combinations of different types. One embodiment may be a magnetometer.

In typical tracking systems, each three-axis sensor and associated signal processing would result in a direction vector or bearing, pointing to the location of the object. In general, three axis sensors are assembled using orthogonal signal axis sensors within a given tolerance. In this novel system, three-axis measurements are not needed, only critically placed, single axis sensors are required. This design would allow for production and manufacturing of all magnetic sensors on the same plane simplifying the manufacturing and deposition of these sensors. Note, that while the preferred embodiment is single vertical-axis, this invention could employ multiple axes based on the situation needed and/or with some sensors left inactive.

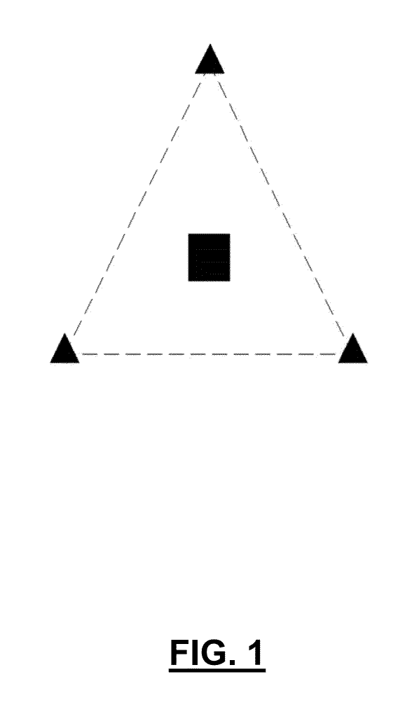

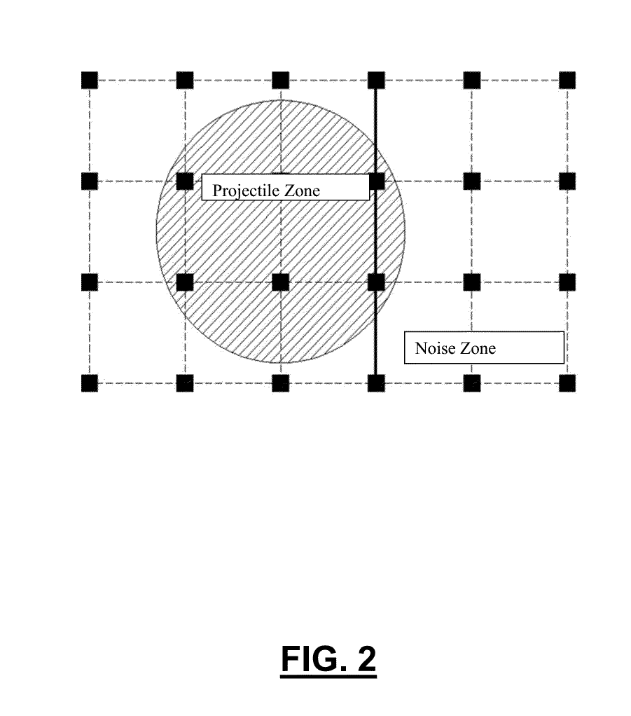

In an embodiment, a specialized sensor network layout is required to compensate for the lack of multi-axis sensors; typical three-axis magnetic sensors can be replaced with a cluster of single axis (for this embodiment, all sensors are vertical, z-axis) magnetic sensors in the same plane. In this embodiment, a sensor cluster will be defined as three single-axis magnetic sensors. This is illustrated in FIG. 1, in which the single axis sensors (triangle) are marked at the center (square) of the sensor cluster. The output of each sensor cluster will include a geometric vector potential, including average magnitude and direction of the sensors' surface normal. Multiple sensor clusters can then be placed in the area of interest. Likewise, the sensors can be apart of more than one cluster. This placement can be a uniform distribution (as shown in FIG. 2 with the maximum detectable magnetic source distance as a reference) or otherwise, such as a varying distribution that is known a priori.

Collecting magnetic sensor information in the “Projectile Zone” as well as in the “Noise Zone” will allow the system to handle magnetic contributions from not only the sources, but also outside influences, such as the Earth's magnetic field and other ambient magnetic noises.

Because the implementation of this algorithm uses the average value of the sensor cluster as well as the surface potential vector, only sensors in each cluster need to be planar (such as having their vertical axes parallel to one another), and not the sensor clusters themselves. This allows for each sensor cluster to be in a different reference plane (pointing in different directions and having different orientations). This corollary can be exploited to allow the sensor clusters to move (during operation) to focus the magnetic sensors “strong axis” in the direction of the target for a better measurement.

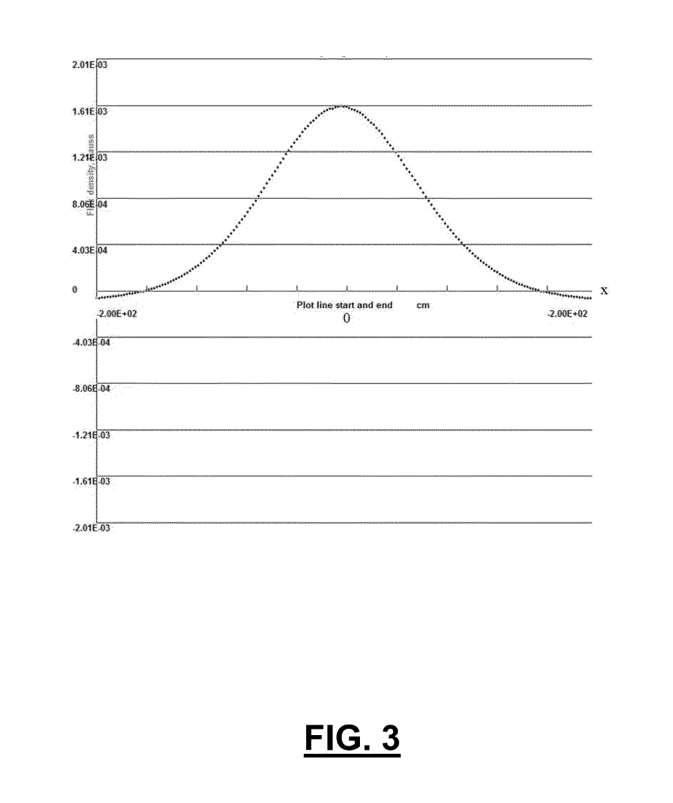

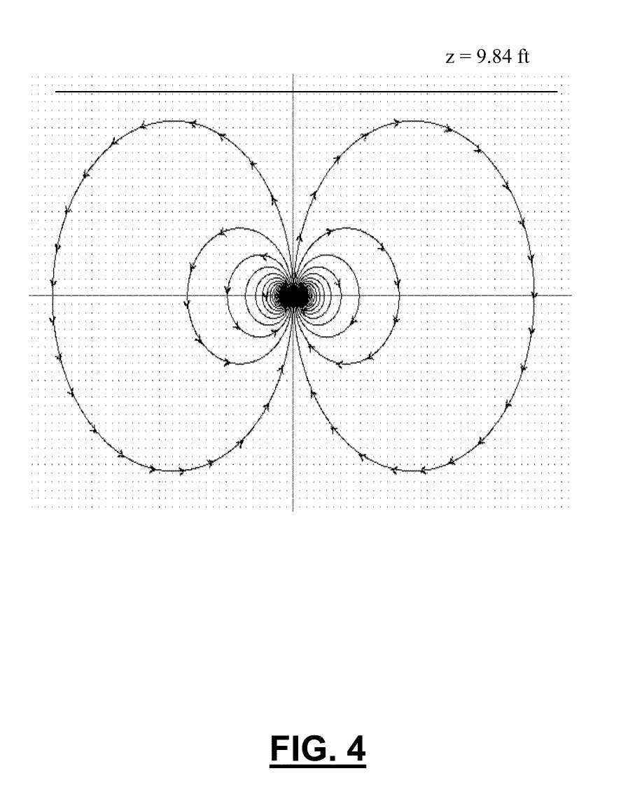

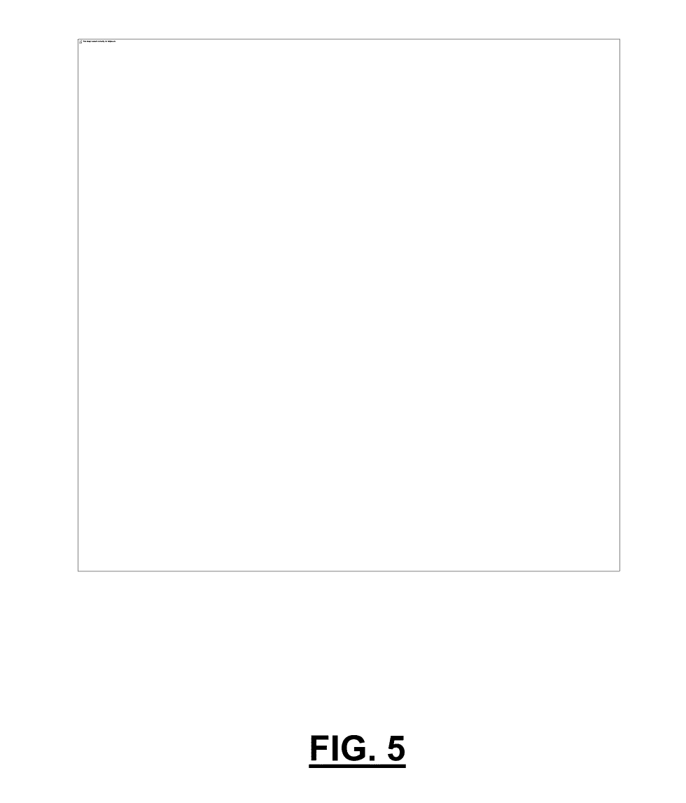

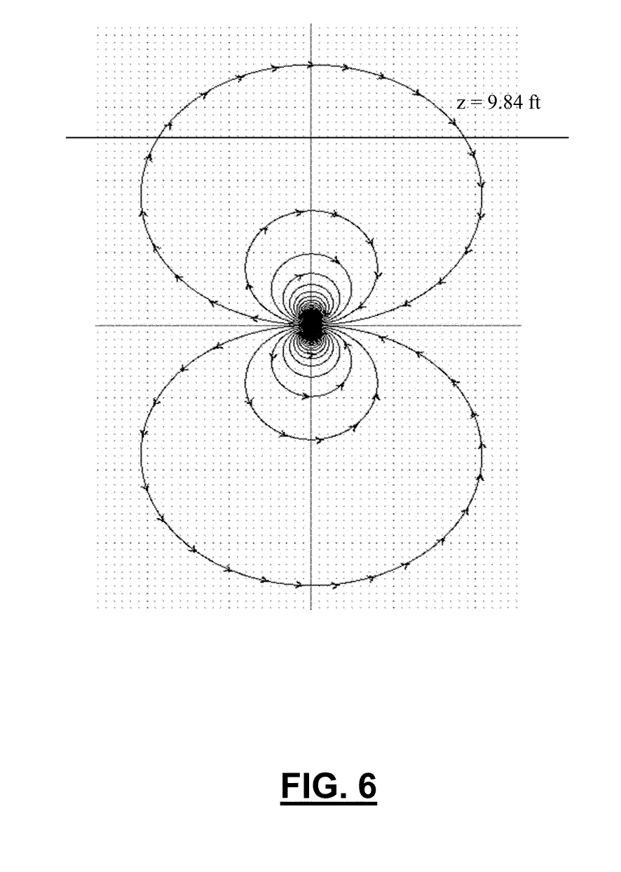

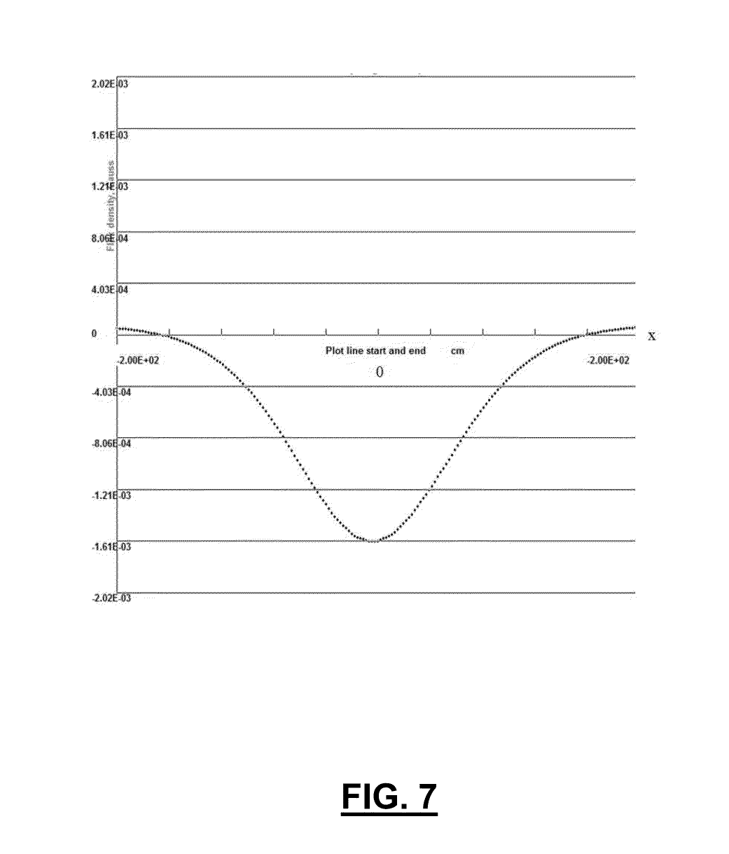

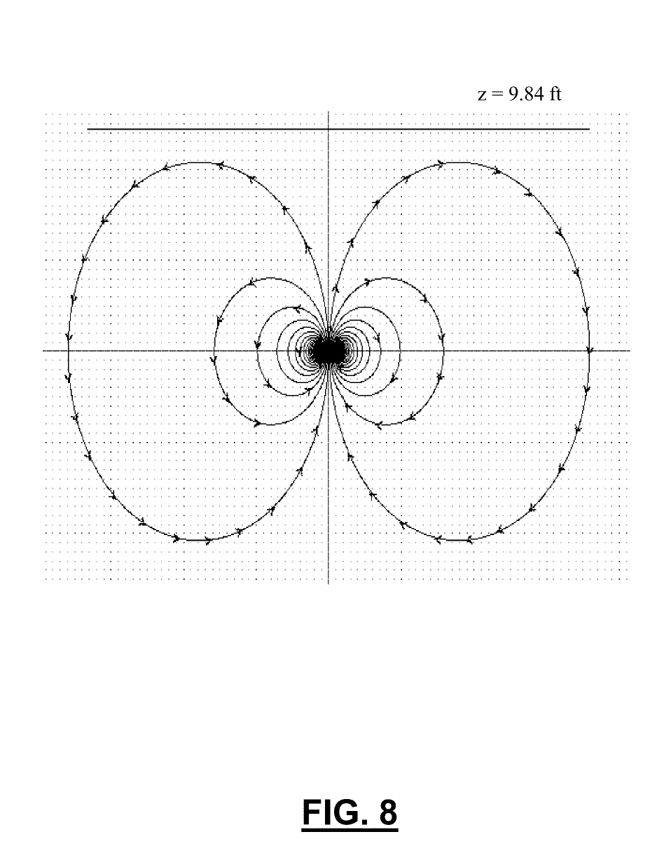

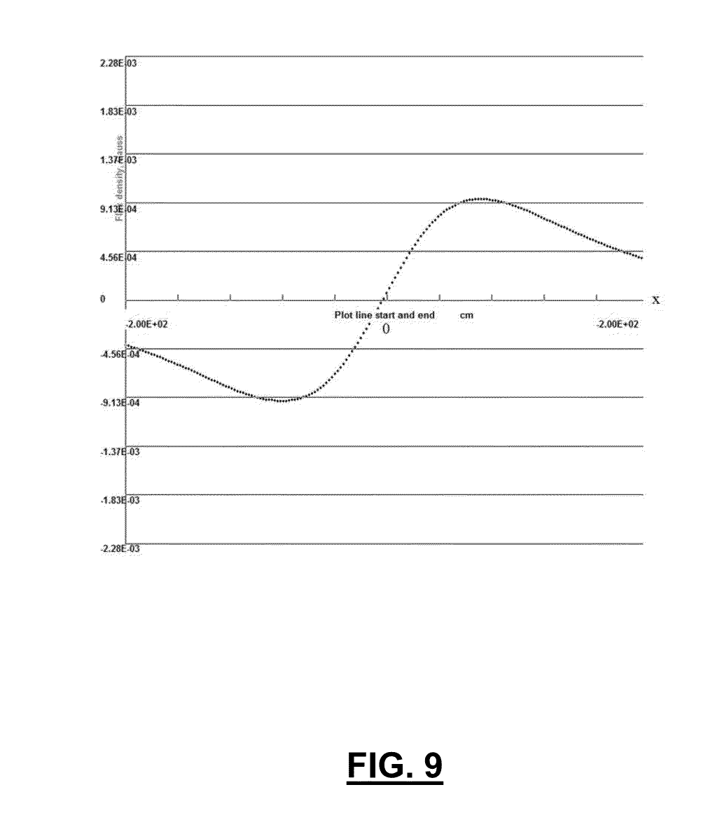

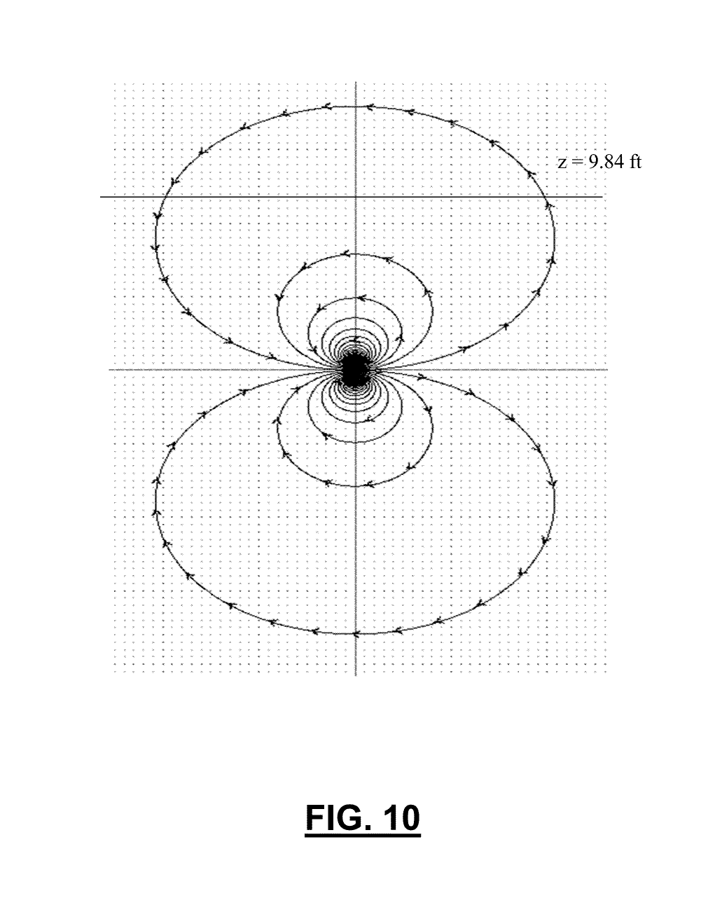

Using the unique characteristics of the magnetic field, such as magnetic strength in one dimension and orientation (FIG. 3-FIG. 10), a prediction algorithm will be able to determine the orientation. Once an absolute orientation is known, the grid position (x, y) can be estimated based upon the point of rotation, and then used to determine orientation. The z-position can be determined based on the same method as in the previous scenario. The original algorithm can then be used to track the magnetic source for the required duration

In this sample, four surface patches have been extracted from the ideal magnetic model. Using the average of the points and the cross product formulas below, the center of the patch and the normal vector to the surface through the center of the patch can be determined.

Given a set Patch is generated by the subset of the positions of three individual sensors at coordinates S₁, S₂, and S₃:

Patchε{S₁,S₂,S₃}

S₁=(S₁ₓ,S_{1y},S_{1z}),

S₂=(S₂ₓ,S_{2y},S_{2z}), and

S₃=(S₃ₓ,S_{3y},S_{3z}), (1)
where S₁, S₂, and S₃ are the positions of each magnetic sensor in Patch, and Sₓ, S_{y}, and S_{z} are the three-dimensional coordinates of each position.
   Patch center and surface normal can be described by:

Patch_{center}=⅓(S₁ₓ+S₂ₓ+S₃ₓ,S_{1y}+S_{2y}+S_{3y},S_{1z}+S_{2z}+S_{3z}), (2)

and

Patchₙₒᵣₘₐₗ=(S₁−S₂)×(S₁−S₃), (3)

and the same can be defined for the remaining patches.

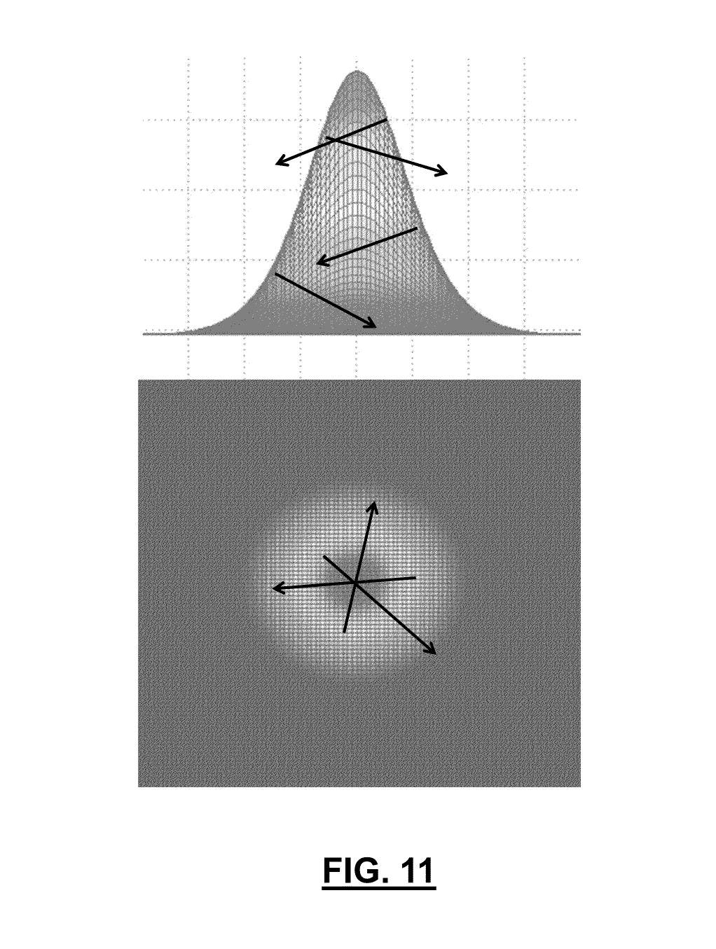

Using vectors defined by the center of these patches and the surface normal through the centers, a geometric union, or intersect of these vectors is not possible in three-dimensional space. However, if this information is projected on a two-dimensional plane (x-y plane), the intersection of these vectors appears at the position of the magnetic source, as shown in FIG. 11.

This two-dimensional intersection is due to the simple, uniform shape of the B-field. Patch_{center} and Patchₙₒᵣₘₐₗ can be described in two-dimensional space as:

Patch_{center}=P=(Pₓ,P_{y}), (4)

and

Patchₙₒᵣₘₐₗ=n=(nₓ,n_{y}) (5)

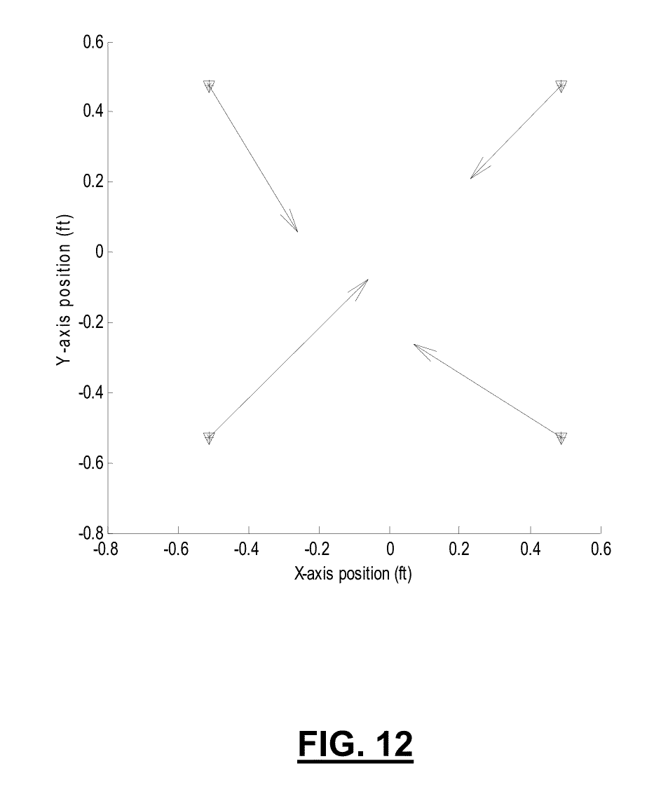

Given points P and surface normal directions n, the same type of analysis can be performed on the x-y plane to determine the coordinates (x,y) of the magnetic source. Using point P as a starting reference in this plane, a new vector can be defined in the direction of the two-dimensional projection of the surface normal vector n. This can be seen in FIG. 12.

In order to determine the intersection of the vectors, a two line, four point intersection matrix was implemented. The following matrix uses two points on the first vector and two points on the second vector to determine the two dimensional intersect point (x,y):

(P₁ₓ,P_{1y}),(P₁ₓ+n₁ₓ,P_{1y}+n_{1y}), (6)

and

(P₂ₓ,P_{2y}),(P₂ₓ+n₂ₓ,P_{2y}+n_{2y}) (7)

which are four points which corresponds to a simultaneous solution of:

$$\vert \begin{matrix}x & y & 1 \\ {P}_{1 x} & {P}_{1 y} & 1 \\ {P}_{1 x} + {n}_{1 x} & {P}_{1 y} + {n}_{1 y} & 1\end{matrix} \vert = 0 , and \vert \begin{matrix}x & y & 1 \\ {P}_{2 x} & {P}_{2 y} & 1 \\ {P}_{2 x} + {n}_{2 x} & {P}_{2 y} + {n}_{2 y} & 1\end{matrix} \vert = 0 \qquad ( 8 )$$

In order to obtain the maximum number of intersection points possible, a statistical

$$( \begin{matrix}n \\ 2\end{matrix} )$$

scheme was used. This allows for the use of 6 intersection points for n=4 patches. The algorithm was adapted to determine

$$( \begin{matrix}n \\ 2\end{matrix} )$$

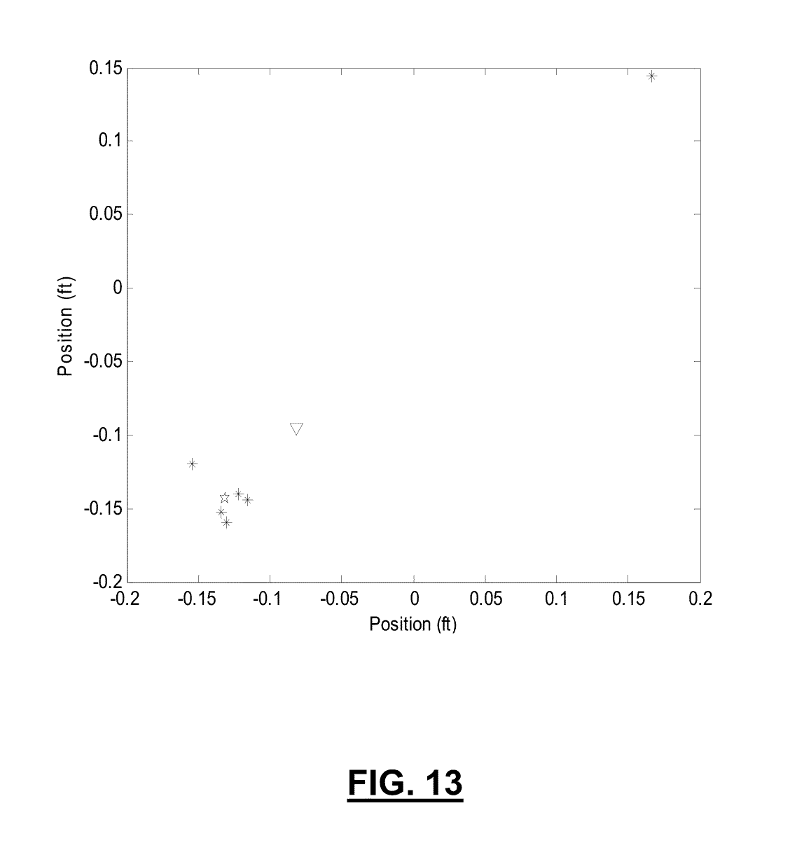

intersection points. The following plot, FIG. 13, shows the x-y intersection of the patches.

The intersection points are denoted as (*) and for n=4 patches, there are six points. The mean of the intersection points is denoted by (∇). To compensate for the phenomenon of statistical outliers, additional statistical analysis will be implemented to account for these points. The mean will be calculated and any data that is outside one standard deviation of the mean will be disregarded. The intersection with outliers removed is denoted by (⋆). This statistical analysis will only be able to be implemented if there are three or more patches (or at least two intersection points). These coordinates along with the z off-set (initially zero), a final three-dimensional position can be offered.

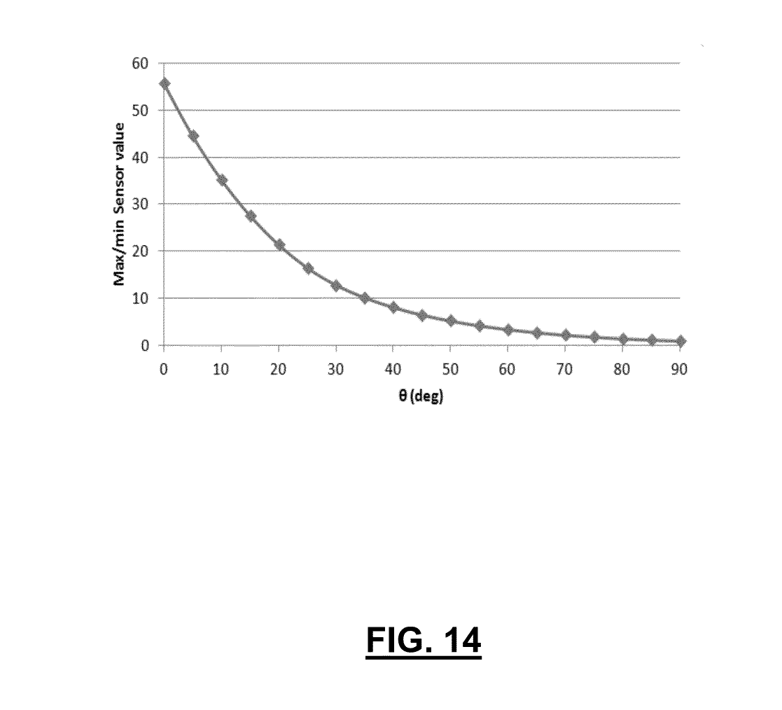

The solution presented thus far assumes that the orientation is always aligned on the z-plane (θ=0). In general, this is not the case and the algorithm must be adapted to account for non-zero orientations. One method to determine elevation is to look at the maximum and minimum sensor values. We have seen that each magnetic orientation produces a unique magnetic field component B_{z} (FIG. 3-FIG. 10), so there should be a function that describe this orientation. Using equation (6), the ratio of the maximum sensor value to the minimum value across the entire network was obtained for 0°≦θ≦90°. The results were fitted empirically to an exponential curve with a goodness-of-fit of 99.84%. The results can be seen in FIG. 14 and described by (9).

$$\frac{{Sensor}_{max}}{{Sensor}_{min}} = 52.256 * {e}^{- 0.045 θ} , \qquad ( 9 )$$

where Sensorₘₐₓ is the maximum sensor value in the network, Sensorₘᵢₙ is the minimum sensor value in the network, an θ is the angle of elevation from the x-y plane.

Given (9), and two sensor values (maximum and minimum), and expression for the elevation of the magnetic source can be written as:

θ=87.91˜22.22*ln(Sensorₘₐₓ/Sensorₘᵢₙ) (10)

Although a more complex peak finding algorithm could be used, this method was chosen for simplicity, and a direct relation to the sensor outputs.

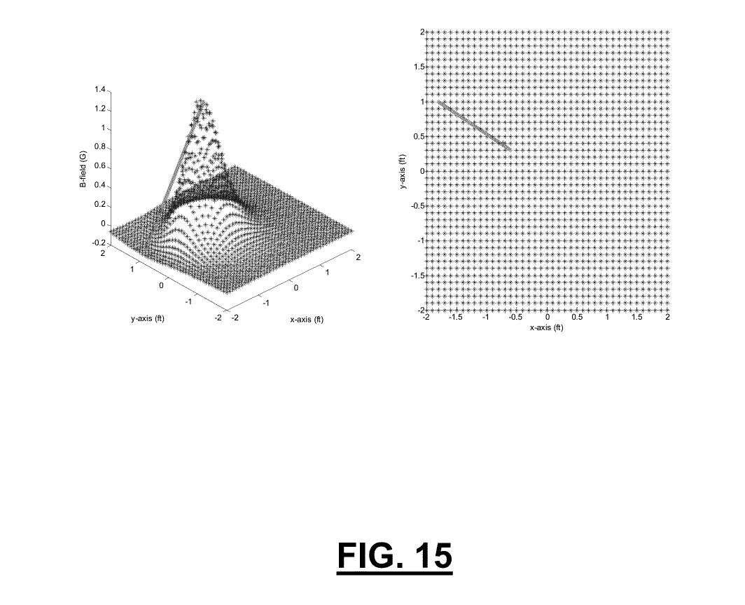

Likewise, the angle of rotation, φ, can be determined by the location of the maximum sensor value and the minimum sensor value. A dense sensor network was created, FIG. 15, with −2≦x, y≦2 ft and a linear sensor spacing of 0.1 inches, where the source is rotating about the origin. Using the maximum and minimum sensor value locations as a reference, angle of rotation, φ, can be determined by the following equation:

$$ϕ = {tan}^{- 1} ( \frac{{Sensor}_{{max}_{x}} - {Sensor}_{{min}_{x}}}{{Sensor}_{{max}_{y}} - {Sensor}_{{min}_{y}}} ) , \qquad ( 11 )$$

where Sensorₘₐₓ is the maximum sensor value in the network (with x and y components) and Sensorₘᵢₙ is the minimum sensor value in the network (with x and y components).

FIG. 15 shows the rotation angle, φ, with respect to all sensor positions, φ, and the position of the maximum value sensor as a reference. The resolution of this angle will depend fully on the number and position of sensors in the network. As the number of sensors in the network increase, resolution for φ will grow.

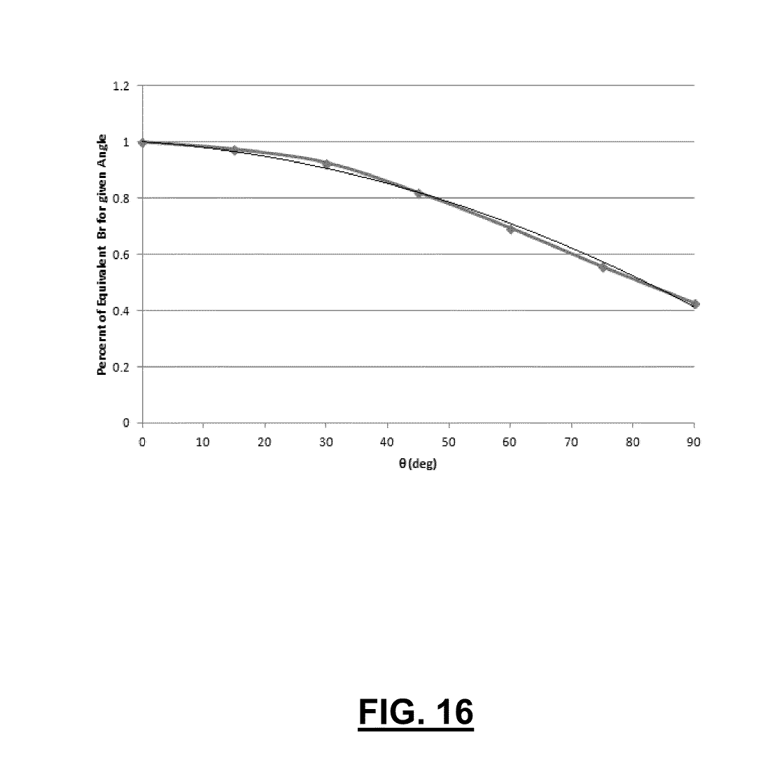

Once the most likely θ and φ are determined, they can then be used in conjunction with the x, y coordinates to determine the z-axis position. Using the same generated sensor network, and the model of an ideal, on-axis dipole, the following plot was created to show the equivalent Bᵣ for a magnet rotated by 0°≦θ≦90°. The expression for FIG. 16 can be seen in (12). Because of the complexity of the analytical expression for the magnetic B-field, this was simplified using a quadratic model with a goodness-of-fit of 99.57% over the range from 0°≦θ≦90°.

Bᵣ_{_{z}}=−6*10⁻⁵*θ²−0.0015*θ+1 (12)

Given the model for an ideal, on axis dipole, the z-component of position can be determined based on the elevation, θ, and the maximum sensor value. This simplification can be exploited because of the position of the magnetic sensors. As the sensor network becomes sparser, error will be introduced into this approximation and a more complex model must be used. Equation (12) can be used in conjunction with (13), an equation for an on-axis magnetic sensor measurement, to determine the on-axis distance away from the magnetic sensor, as seen in (14).

$$\begin{matrix}{Sensor}_{max} = \frac{{B}_{{r}_{z}}}{{z}^{3}} , & ( 13 ) \\ & \\ z = \sqrt[3]{\frac{{B}_{{r}_{z}}}{{Sensor}_{max}}} = \sqrt[3]{\frac{- 6 * {10}^{- 5} * {θ}^{2} - 0.0015 * θ + 1}{{Sensor}_{max}}} , & ( 14 )\end{matrix}$$

where Sensorₘₐₓ is the maximum sensor value in the network, θ is the elevation, and B_{rz} is the maximum on axis B-field generated by rotation the magnet.

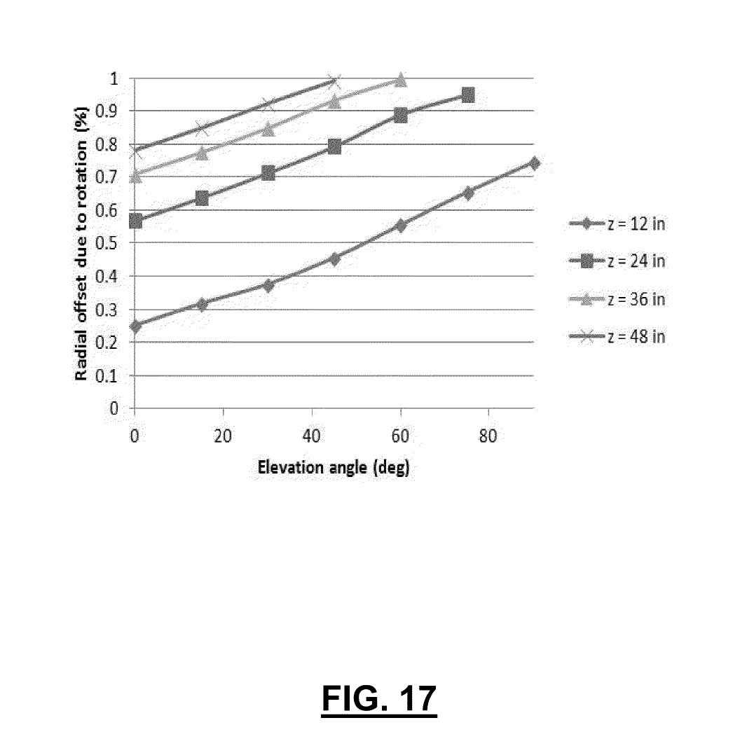

The initial method for determining position assumed no elevation of the magnetic source (θ=0°). Since an elevation and rotation component now exists, the x-y position must be modified. As the magnetic source is rotated the position of the maximum and minimum sensor points begin to collapse in on themselves, and an offset correction must be provided. Note that during operation, the magnetic source can be as close as 12 inches to the sensor network, FIG. 17, shows a model for an offset based on the output of the proposed solver algorithm for 12, 24, 36, and 48 inches.

The data in this plot was generated by a radius of 10 inches; however, the process would be the same for any rotating magnetic source.

These lines can be collapsed to a single expression (15) where percent radial offset can be described as a function of both the angle of elevation (θ, linear) and approximate z-axis position (z, quadratic) with a goodness-of-fit of 99.22% for 12≦z≦48 inches, 0°≦θ≦45° and additional elevations in FIG. 17.

$${Offset}_{percent - radial} = 0.0051 * θ + ( - 0.0652 * {( \frac{z}{12} )}^{2} + 0.5058 * \frac{z}{12} - 0.2067 ) \qquad ( 15 )$$

And the position (x,y) can be modified from the θ=0° elevation to the actual orientation of the magnetic source via equations (16) and (17).

x=x_{θ=0}+(Radius*Offset_{percent-radial})cos(θ) (16)

Y=y_{θ=0}+(Radius*Offset_{percent-radial})sin(θ) (17)

By using the methods in this section, we have determined the three dimensional position (x, y, z) and orientation (θ and φ) based solely from the geometry of the B-field and the outputs of an array of single axis (z-axis) magnetic sensors.

The triangulation is performed via hardware and computer software at real-time or near real-time speed. Computer software could include an estimation algorithm using a kinematic model of the source (i.e. the object being tracked). The model simulates the behavior of the source in travel, which is fed relevant information gathered from the sensors, such as orientation, position, speed and acceleration. The model can then determine an improved estimate of position by estimation techniques, such as Kalman filtering.

Kalman filters use state transition model and control inputs to help predict future states of a system. A typical Kalman filtering algorithm includes two parts: predict and update equations.

### Predict

Determine predicted (a priori) state estimate (\hat{x}) and estimate covariance (P) at instance k.

\hat{x}_{k|k-1}=Aₖ\hat{x}_{k-1|k-1}+Bₖuₖ+wₖ, (17)

z_{k|k-1}=Hₖ\hat{x}_{k|k-1}+vₖ, (18)

and

P_{k|k-1}=AₖP_{k-1|k-1}Aₖ^{T}+Qₖ, (19)

given

p(wₖ)˜N(0,Qₖ), (20)

p(vₖ)˜N(0,Rₖ), and (21)

where A is the state transition matrix, B is the control input matrix, H is the measurement output matrix, u is the control input vector, w is the process noise, v is the measurement noise, and Q is the covariance of process noise, and R is the covariance of the measurement noise.

### Update

Calculate (a posteriori) updated innovation or measurement residual (ŷ), innovation covariance (S), covariance of the measurement noise (R), optimal Kalman gain (K), and updated (a posteriori) state estimate (\hat{x}) and estimate covariance (P) given true measurement (z).

ŷₖ=zₖ−Hₖ\hat{x}_{k|k-1}, (22)

Sₖ=HₖP_{k|k-1}Hₖ^{T}+Rₖ, (23)

Kₖ=P_{k|k-1}Hₖ^{T}Sₖ⁻¹, (24)

\hat{x}_{k|k}=\hat{x}_{k|k-1}+Kₖŷₖ, (25)

and

P_{k|k}=(I−KₖHₖ)P_{k|k-1}, (26)

As for developing the filter, the state transition model, control model, and other inputs are based upon the motion equations governing the system. For an object moving in free space with only the effect of gravity, discrete kinematic equations can be described as:

Xₖ₊₁=Xₖ+VₖΔt+½AₖΔt², (27)

and

Vₖ₊₁=Vₖ+AₖΔt, (28)
where X is position, V is velocity, A is acceleration, and Δt is the time step between each iteration, k.

Vector equations for position, velocity, and acceleration are expanded such that X=(xₖ,yₖ, zₖ), V=(\dot{x}ₖ, \dot{y}ₖ, żₖ), and A=(\ddot{x}ₖ, ÿₖ, \ddot{z}ₖ) and the following state-space model can be formed.

$$[ \begin{matrix}{X}_{k + 1} \\ {V}_{k + 1}\end{matrix} ] = [ \begin{matrix}{x}_{k + 1} \\ {y}_{k + 1} \\ {z}_{k + 1} \\ {\dot{x}}_{k + 1} \\ {\dot{y}}_{k + 1} \\ {\dot{z}}_{k + 1}\end{matrix} ] = [ \begin{matrix}1 & 0 & 0 & Δ t & 0 & 0 \\ 0 & 1 & 0 & 0 & Δ t & 0 \\ 0 & 0 & 1 & 0 & 0 & Δ t \\ 0 & 0 & 0 & 1 & 0 & 0 \\ 0 & 0 & 0 & 0 & 1 & 0 \\ 0 & 0 & 0 & 0 & 0 & 1\end{matrix} ] [ \begin{matrix}{x}_{k} \\ {y}_{k} \\ {z}_{k} \\ {\dot{x}}_{k} \\ {\dot{y}}_{k} \\ {\dot{z}}_{k}\end{matrix} ] + [ \begin{matrix}\frac{1}{2} {Δ t}^{2} & 0 & 0 \\ 0 & \frac{1}{2} {Δ t}^{2} & 0 \\ 0 & 0 & \frac{1}{2} {Δ t}^{2} \\ Δ t & 0 & 0 \\ 0 & Δ t & 0 \\ 0 & 0 & Δ t\end{matrix} ] [ \begin{matrix}{\ddot{x}}_{k} \\ {\ddot{y}}_{k} \\ {\ddot{z}}_{k}\end{matrix} ] \qquad ( 29 )$$

Based on the Kalman filtering algorithm, the following implementation can be used based on Newtonian physics.

Xₖ₊₁=AₖXₖBₖ\ddot{X}ₖ+wₖ, (30)

and

Zₖ=HₖXₖvₖ, (31)
where Aₖ is the state transition model, Bₖ is the acceleration input matrix, Hₖ is the model output matrix, Zₖ is the true measurement, wₖ is the process noise, and vₖ is the measurement noise.

Because Aₖ and Bₖ are constants based on kinematic models, and will not change during operation, simplifications of Aₖ=A and Bₖ=B can be applied. Additionally, calculations will assume equal time steps per iteration, based on the sampling frequency (Δt=1/fₛ). A simplistic model for the process noise, Qₖ, can then be introduced based on the model's acceleration inputs and variance.

Qₖ=diag{σₚ_{ₓ}²,σₚ_{_{y}}²,σₚ_{_{z}}²,σ_{\dot{p}}_{ₓ}²,σ_{\dot{p}}_{_{y}}²,σ_{\dot{p}}_{_{z}}²,}, (32)
where σₚ² is the process noise variance of the position and σ_{\dot{p}}² is the process noise variance of the velocity, in x, y, z, respectively.

Note, this is the most basic model for process noise. It includes no coupling between components, or even between positions and velocities of the same component. Although a more complex model can and should be created, the output of the system will show that even this very simplistic model will increase the effectiveness of the estimation algorithm. The process noise variance of the position and velocity can be modeled (for a simplistic case) based on the maximum acceleration in the system, where

$$\begin{matrix}{σ}_{x}^{2} = {σ}_{y}^{2} = {σ}_{z}^{2} = \frac{{{a}_{max} ( Δ t )}^{2}}{2} & ( 33 ) \\ {σ}_{\dot{x}}^{2} = {σ}_{\dot{y}}^{2} = {σ}_{\dot{z}}^{2} = {a}_{max} Δ t & ( 34 )\end{matrix}$$

The output matrix, based both on position and velocity states, can be defined as:

Hₖ=diag{1,1,1,1,1,1}, (35)
where the first set of three values are for x, y, z position and the second set are for Vₓ, V_{y}, V_{z}.
   The most simplistic covariance of measurement noise, based solely on uncoupled variances of position and velocities (like the process noise) and on the accuracy and repeatability of the sensor used, can be defined as:

Rₖ=diag{σₘ_{ₓ}²,σₘ_{_{y}}²,σₘ_{_{z}}²,σ_{\dot{m}}_{ₓ}²,σ_{\dot{m}}_{_{y}}²,σ_{\dot{m}}_{_{z}}²,}, (36)
where σₘ² is the measurement noise variance of the position and σ_{\dot{m}}² is the measurement noise variance of the velocity, in x, y, z, respectively.

Qₖ=Q, Rₖ=R, and Hₖ=H (matrices are constant) can be applied for this simplified case. The Kalman filtering algorithm also requires a set of initial states for the state transition model as well as for the estimate covariance. These values are dependent upon whether the initial states are known (measurements are trusted) or unknown (model is trusted).

Initial states based from unknown position and velocity can assume a position at the origin.

$$[ \begin{matrix}\hat{{X}_{k}} \\ {{X}_{k}}^{\hat{.}}\end{matrix} ] = [ \begin{matrix}{\hat{x}}_{k} \\ {\hat{y}}_{k} \\ {\hat{z}}_{k} \\ {{x}^{\hat{.}}}_{k} \\ {{y}^{\hat{.}}}_{k} \\ {{z}^{\hat{.}}}_{k}\end{matrix} ] {\to }^{y i e l d s} [ \begin{matrix}0 \\ 0 \\ 0 \\ {v}_{x} \\ {v}_{y} \\ {v}_{z}\end{matrix} ] \qquad ( 37 )$$

Whereas initial states based from known position and velocity can assume the actual position and velocity:

$$[ \begin{matrix}\hat{{X}_{k}} \\ {{X}_{k}}^{\hat{.}}\end{matrix} ] = [ \begin{matrix}{\hat{x}}_{k} \\ {\hat{y}}_{k} \\ {\hat{z}}_{k} \\ {{x}^{\hat{.}}}_{k} \\ {{y}^{\hat{.}}}_{k} \\ {{z}^{\hat{.}}}_{k}\end{matrix} ] {\to }^{y i e l d s} [ \begin{matrix}{x}_{0} \\ {y}_{0} \\ {z}_{0} \\ {\dot{x}}_{0} \\ {\dot{y}}_{0} \\ {\dot{z}}_{0}\end{matrix} ] \qquad ( 38 )$$

Initial estimate covariance based on known position and velocity yields:

$${P}_{0 \vert 0} = [ \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} ] = 0 \qquad ( 39 )$$

This estimate covariance matrix assumes that there is a small amount of measurement noise (and/or ambient noise, or other errors) and that the measurement values should be “trusted” more than the estimator “values”.
Initial estimate covariance based on unknown position and velocity can be assumed as:

$${P}_{0 \vert 0} = [ \begin{matrix}{L}_{x} & 0 & 0 & 0 & 0 & 0 \\ 0 & {L}_{y} & 0 & 0 & 0 & 0 \\ 0 & 0 & {L}_{z} & 0 & 0 & 0 \\ 0 & 0 & 0 & {L}_{\dot{x}} & 0 & 0 \\ 0 & 0 & 0 & 0 & {L}_{\dot{y}} & 0 \\ 0 & 0 & 0 & 0 & 0 & {L}_{\dot{z}}\end{matrix} ] , \qquad ( 40 )$$

where diag{Lₓ, L_{y}, L_{z}, L_{\dot{x}}, L_{\dot{y}}, L_{ż}} is suitably larger than the states of X and V.

This estimate covariance matrix assumes that there is a larger amount of measurement noise (and/or ambient noise, or other errors) and that the model should be “trusted” more than the measurements. Both matrices will evolve with the estimator over time.

A tracker-observer system can then be developed using this algorithm. One real-world case examined is that of projectile motion. In this case, a projectile is moving in free-space with only the force of gravity acting upon it. In more complicated cases, the motion equations presented here will need to be modified to account for friction or other influential forces (such as aerodynamic drag).

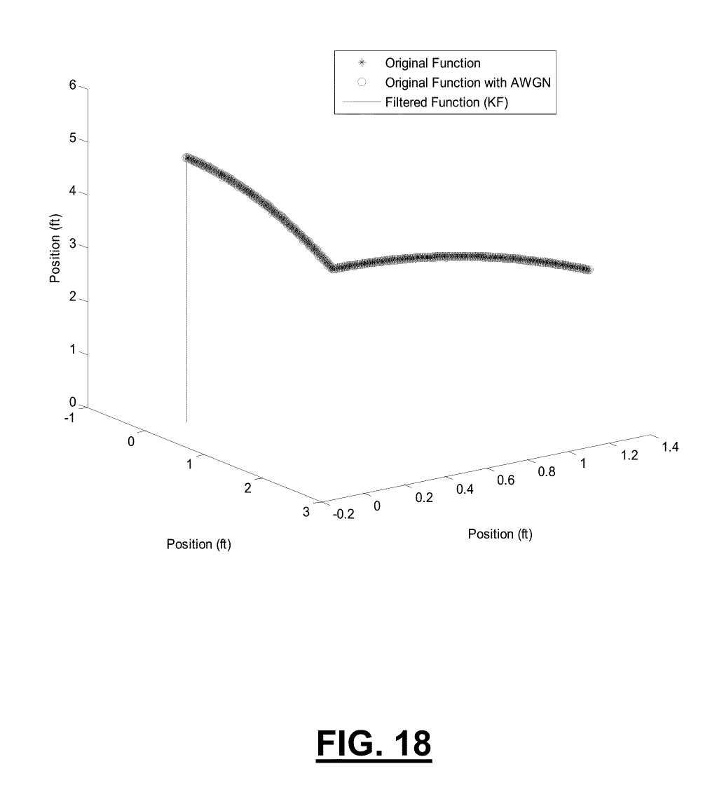

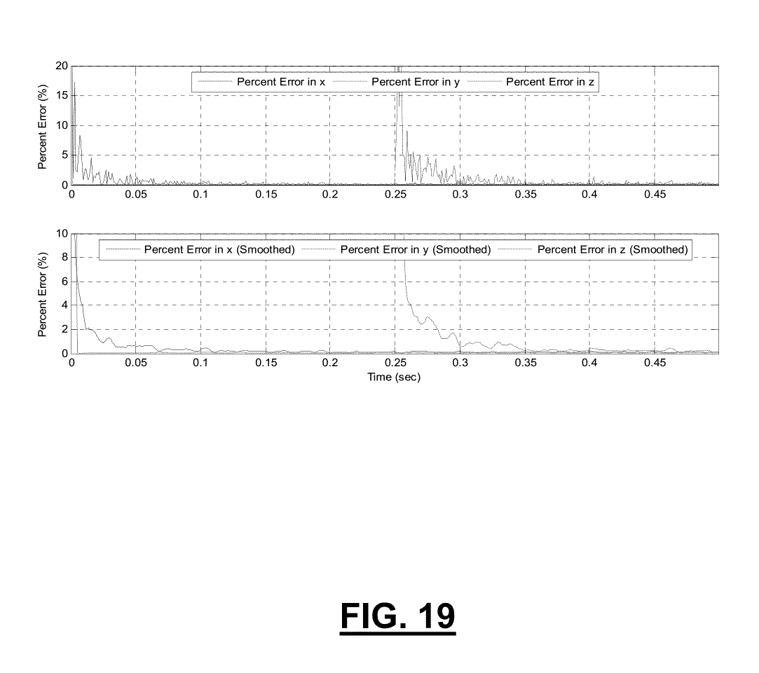

In an example of this model, the projectile travels 0.25 seconds with initial velocity of 120 inches/sec until it is deflected 90° and continues to travel in a new projectile motion for 0.25 seconds with a new initial velocity of 60 inches/sec. Simulation used a process noise based on aₘₐₓ=100 g and a measurements noise σₘ²=0.00001 ft², suggested by as an appropriate estimate for the magnetometer, as a with a sampling frequency of 1 kHz. The results can be seen in FIG. 18 and FIG. 19.

FIG. 19 shows the convergence of a solution for the initial motion (between 0 and 0.25 seconds) as well as the second motion (between 0.25 and 0.5 sec). The first motion converges with error under 5% within 0.02 second (18 iterations) and the second within 0.01 seconds (9 iterations) and both eventually settle below 0.1% error over the length of the simulation, with minimal initial overshoot. This figure also shows the error smoothed with a moving average filter (n=10).

By using a Kalman filter, with an initial position estimation, based on a kinematic model, noisy measurement data can be used, as shown, to predict the position and velocity of a projectile with minimal error. Using this algorithm or a similar one in conjunction with the magnetic tracking algorithm proposed earlier, a system can be developed to track a magnetic source moving in three-dimensional space.

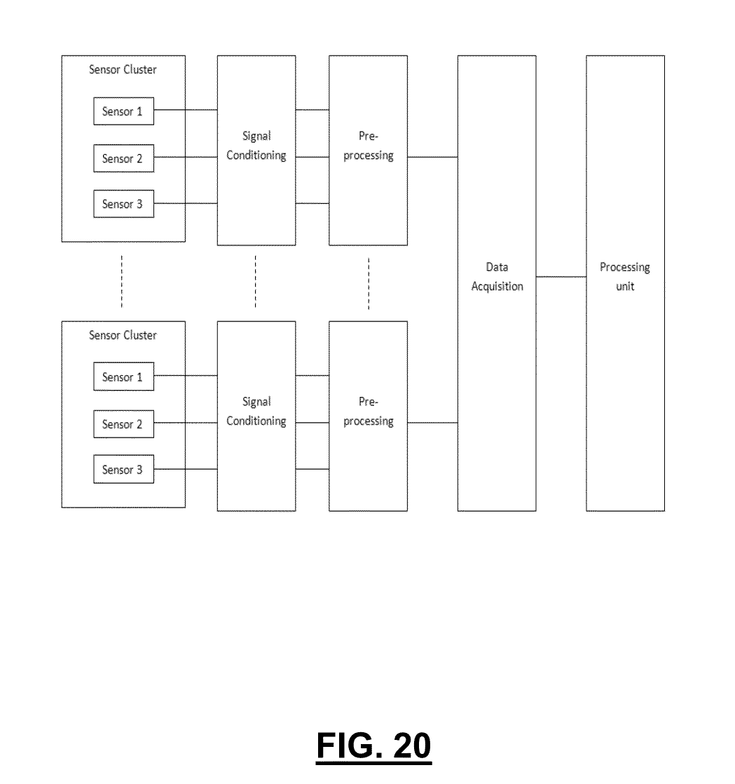

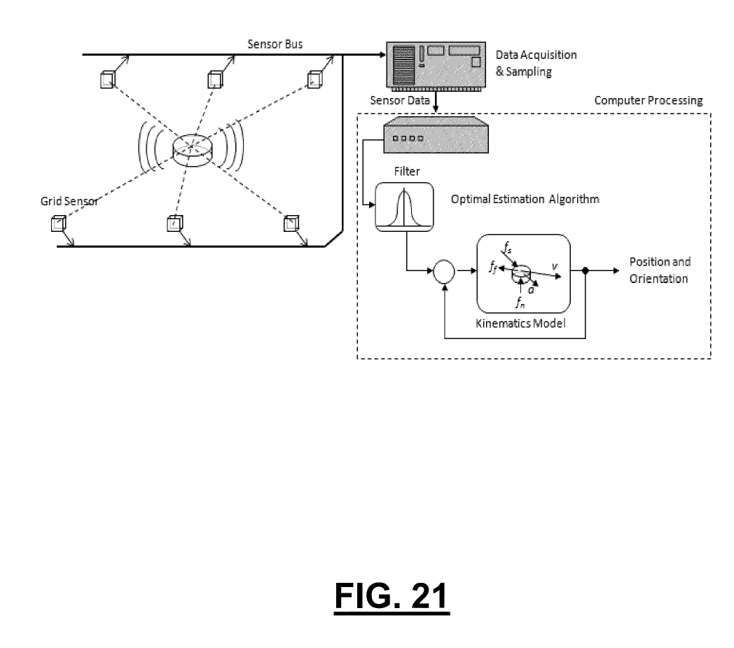

Data acquisition hardware will include not only the magnetic sensor clusters, but also signal conditioning, amplification circuits, digital conversions, estimation modeling, and filtering to predict three-dimensional position and orientation as commonly used in the field of signal processing. Single-axis magnetic field strength measurements from each of the sensors in the clusters could be collected by a preprocessor (microcontroller) after being conditioned appropriately. Pre-processing could supply pertinent position information for each cluster, including average magnetic strengths and geometric surface potentials, without having to transfer all of the sensor data directly to the computer for processing. This information will be transferred via a data bus (electrical, wireless, optical, or otherwise) to a data acquisition unit that can quantize the analog signal for use in the processing unit. This information can then be used to calculate one instance of position of the object, using the method shown above. This process is illustrated in FIG. 20. Additionally, a block diagram of one possible embodiment of the system is given in FIG. 21.

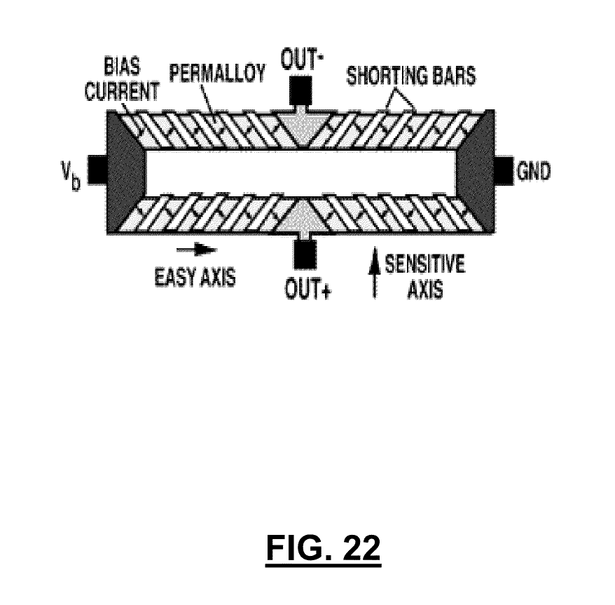

One possible type of magnetic sensor used in the construction of this sensor network is an anisotropic magnetoresistive (AMR) sensor. Introduced in 1999 [1], AMR sensors use a nickel-iron, permalloy, in a Wheatstone bridge configuration. A sample can be seen in FIG. 22.

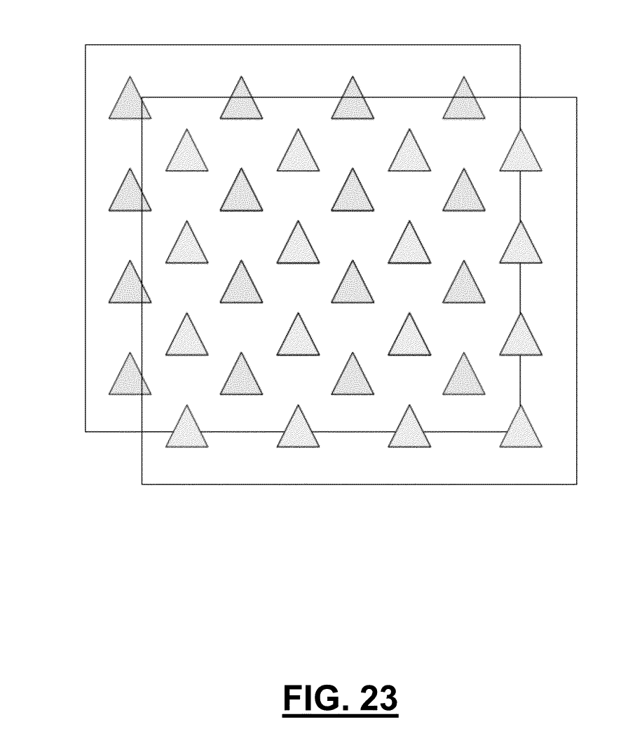

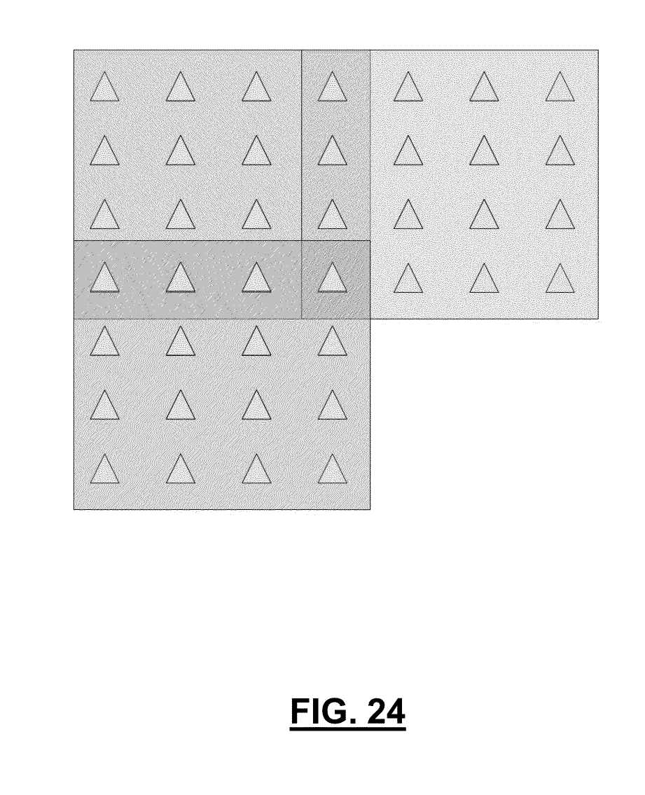

The permalloy is imprinted on a silicon wafer with the above geometry. Multi-dimensional sensors use multiple orthogonal AMR sensors all cut from the same substrate. Because the proposed tracking algorithm has the ability to only use a single-axis magnetic sensor, magnetic sensors can be created, in the same substrate, with all the “sensitive axes” in line. This would create a sensor network like the one suggested in the previous section. Since the magnetic sensor will be printed on a known, relative thin silicon sheet, it would be possible to combine layers of these sheets to create a denser sensor network or a sensor network of any size, as shown in FIGS. 23 and 24. Using these configurations, a magnetic sensor network of any size with any density (uniform or otherwise) could be created from identical magnetic sensor sheets for a given scenario.

The following are potential uses for embodiments of the invention.

Sporting events have occupied an important part of our leisure time for decades, and inaccurate calls, even when done inadvertently or accidentally can, and often do, change the outcome of the game. Often, improper or inaccurate calls by a scoring official also result in a delay in the game and loss of momentum for both the teams and the spectators. In some sports, such as ice hockey, the actions associated with the scoring process can create significant problems. This is particularly true when the field of view is obscured by players or their equipment. Additionally, the speed of the puck and the actions and interactions of the skaters surrounding it can easily hide the progress on, or near, the goal line.

To facilitate the calls of the officials, video equipment and the availability of video play-back can aid in the decision making process. In some applications, high speed video cameras blanket the rink, covering the visible ice from as many angles as possible. Unfortunately, even all of this visual monitoring equipment can be blocked, making this situation even more difficult to call. Clearly what is needed is a detection protocol where the players and their equipment are transparent to the system.

Attempts have been made in the past to track the puck on the ice. This was mainly for television viewers to be able to locate the puck while in action. Previous methods attempting to perform goal detection were based solely on visible recognition, and therefore were not accurate enough for goal tracking because the puck is often occluded by the goal keeper or other players. The novel method of using magnetic sources and sensors described in this document will propose a tracking system that is not dependant on visual interpretation.

In another possible embodiment, a small scale magnetic system could be used to track merchandise in-store or in-warehouse for security or inventory purposes. Much like magnetic security devices that are used to protect expensive electronics in stores today, a small magnetic source could be embedded in product packaging and be used to detect concealed merchandise leaving the premises, as well as its movements from warehouse, to store, to consumer.

Although there will not be enough information to uniquely identified specific products, this system could be used to quickly identify packages marked as expensive, perishable, dangerous, or otherwise differentiable. A system such as this would no longer make removing specialized security devices necessary, which assumes that the product re-entering the store for return does not interfere with the inventory management system.

A simple implementation, similar to the sport event embodiment, includes a small, inconspicuous magnetic sensor network that could be deployed around doorways, thresholds, or in specific areas of warehouses or storage areas with the ability to detect when merchandise enters and exits. This sensor network could be connected to a data acquisition system capable of detecting a magnetic signal as small as a few hundred milligauss. Information about the product and number of products could be then directed to the store's inventory management system.

In an embodiment, a magnetic source could be used to track bodily functions or map organs such as the intestinal tract or blood stream. This sensor grid would consist of an arrangement of magnetic sensors incorporated in a suitable substrate sheet that is embedded in an examination table. Again, due to the nature of the magnetic field, and its ability not to be limited to line of site, tracking magnetic sources in the body will be much like tracking outside of the body.

Additional modifications will be needed for inter-body tracking. The first and foremost will be the size and strength of the magnetic signature. The size of the source will be dictated by the application, “milli” scale for intestinal tract and “nano” scale for blood/vein mapping. Because of the size/strength relationships between most magnetic materials the strength of the magnet will also need to be reduced. Current magnetic resonance imaging (MRI) machines use magnetic field between 4.7 kG and 47 kG, but these fields are exterior to the body and are then reduced over distance. Although the body is able to tolerate large static magnetic fields, it does not fare as well with dynamic magnetic fields. If a magnetic source was to be introduced to the body, it would need to be small, as to not create a large dynamic magnetic field, which has been linked to leukemia.

Clarity and precision will be critical in this embodiment. Since the patient will be confined to the examination table, the magnetic sensors will only need to have a vertical range of the width of a body (approximately 18 in), instead of multiple feet as would be needed for large scale object tracking. In order to ensure needed details, the sensor network, or sensor substrate, will need to be denser. It may be necessary for several hundred sensors to be used and in varying configurations for suitable clarity. All data collection equipment, filters, and prediction models will be similar, as in the previous embodiments.

The invention has been described above and modifications and alterations will occur to others upon a reading and understanding of this specification. The claims as follows are intended to include all modifications and alterations insofar as they come within the scope of the claims or the equivalent thereof

Having thus described the invention, we claim:

1. An object tracking system comprising:
a sensor grid comprising a plurality of sensor clusters configured to sense the presence of an object having a source capable of generating a magnetic field;
wherein each sensor cluster comprises three or more single-axis magnetic sensors;
wherein the sensor grid comprises a first zone near the object and a second zone including all area within the sensor grid not in the first zone; and
wherein the system is configured to update the ambient magnetic field reading of sensors within the second zone.

2. The object tracking system of claim 1, wherein the first zone comprises the area of the sensor grid where the magnetic field read by the sensors from the source object is greater than the ambient magnetic noise.

3. The object tracking system of claim 1, wherein the sensors in a cluster are arranged with their axes parallel to one another.

4. The object tracking system of claim 1, wherein the axes of sensors in a first cluster are not parallel to axes of sensors in a second cluster.

5. The object tracking system of claim 1, wherein at least one of the sensors is an anisotropic magnetoresistive sensor.

6. The object tracking system of claim 1, wherein the system detects up to three degrees of position and up to three degrees of orientation.

7. The object tracking system of claim 1, wherein the single-axis is a vertical axis.

8. The object tracking system of claim 1, wherein each cluster comprises three sensors.

9. The object tracking system of claim 1, wherein the sensors in each cluster are uniformly spaced apart.

10. The object tracking system of claim 1, wherein the system further includes one or more of signal conditioning, amplification circuits, digital conversions, estimation modeling, and filtering.

11. The object tracking system of claim 1, wherein the source is a permanent magnet.

12. The object tracking system of claim 1, wherein each sensor within a cluster is separated by a distance from the remaining sensors within a cluster.

13. The object tracking system of claim 12, wherein each distance between the sensors is great enough to magnetically isolate each sensor from the others.

14. An object tracking system comprising:
a sensor grid comprising a plurality of sensor clusters configured to sense the presence of an object having a source capable of generating a magnetic field;
wherein the at least a portion of the sensor grid comprises a plurality of sensors printed on a first common sheet; and
wherein each sensor cluster comprises three or more single-axis magnetic sensors.

15. The object tracking system of claim 14, wherein the grid includes a second common sheet having a plurality of magnetic sensors printed thereon overlapping the first common sheet.

16. The object tracking system of claim 15, wherein the first and second common sheets are arranged such that the magnetic sensors of the first common sheet are magnetically isolated from the magnetic sensors on the second common sheet.

17. The object tracking system of claim 14, wherein the grid includes a second common sheet having a plurality of magnetic sensors printed thereon positioned adjacent to the first common sheet and connected thereto.

18. A method of tracking an object comprising:
providing a sensor grid comprising a plurality of sensor clusters configured to sense the presence of an object having a source capable of generating a magnetic field;
determining up to three degrees of positioning for the object based on a geometric solution of the intercepts of magnetic field strengths obtained from information collected by the magnetic sensors; and
determining up to three degrees of orientation for the object based on a geometric solution of the intercepts of magnetic field strengths obtained from information collected by the magnetic sensors.

19. The method of tracking an object in claim 18, wherein the sensor grid includes a plurality of single-axis magnetic sensors and appropriate signal conditioning techniques to collect a usable signal.

20. The method of tracking an object in claim 18, wherein the solution for determining up to three degrees of position and up to three degrees of orientation uses a statistical model for determining position and a kinematic model for tracking.
